(19) United States
(12) Patent Application Publication
(10) Pub. No.: US 2006/0050961 A1
(43) Pub. Date: Mar. 9, 2006

(54) Method and system for locating and verifying a finder pattern in a two-dimensional machine-readable symbol

(76) Inventor: Mohanaraj Thiyagarajah, Scarborough (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/918,722

(22) Filed: Aug. 13, 2004

(51) Int. Cl. G06K 9/00; G06K 9/36; G06K 19/06

(52) U.S. Cl. 382/181; 382/232; 235/462.03

(57) ABSTRACT

A method of locating and verifying a finder pattern in a two-dimensional machine-readable symbol, comprises scanning the image along a line to locate a sequence of regions having different optical properties corresponding to that which would be encountered along a line passing through the center of the finder pattern thereby to locate a candidate finder pattern. When a candidate finder pattern is located, performing a multi-stage verification to verify that the candidate finder pattern is an actual finder pattern.

### FIELD OF THE INVENTION

The present invention relates generally to symbol recognition and more specifically, to a method and system for locating and verifying a finder pattern in a two-dimensional machine-readable symbol.

### BACKGROUND OF THE INVENTION

Marking documents with machine-readable characters to facilitate automatic document recognition using character recognition systems is well known in the art. In many industries, labels are printed with machine-readable symbols, often referred to as barcodes, and are applied to packages and parcels. The machine-readable symbols on the labels typically carry information concerning the packages and parcels that is not otherwise evident from the packages and parcels themselves.

For example, one-dimensional barcode symbols, such as those following the well-known Universal Product Code (UPC) specification, regulated by the Uniform Code Council, are commonly used on machine-readable labels due to their simplicity. A number of other one-dimensional barcode symbol specifications have also been proposed, such as for example POSTNET that is used to represent ZIP codes. In each case, the one-dimensional barcode symbols governed by these specifications have optimizations suited for their particular use. Although these one-dimensional barcode symbols are easily scanned and decoded, they suffer disadvantages in that they are only capable of encoding a limited amount of information.

To overcome the above disadvantage associated with one-dimensional barcode symbols, two-dimensional machine-readable symbols have been developed to allow significantly larger amounts of information to be encoded. For example, the AIM Uniform Symbology Specification For PDF417 defines a two-dimensional barcode symbol format that allows each barcode symbol to encode and compress up to 1108 bytes of information. Information encoded and compressed in each barcode symbol is organized into a two-dimensional data matrix including between 3 and 90 rows of data that is book-ended by start and stop patterns. Other two-dimensional machine-readable symbol formats such as for example AZTEC, QR Code and MaxiCode have also been considered.

Although two-dimensional machine-readable symbols allow larger amounts of information to be encoded, an increase in sophistication is required in order to read and decode such two-dimensional symbols. In fact decoding two-dimensional symbols often requires relatively large amounts of computation. As a result, it is desired to ensure that two-dimensional symbols are read properly before the decoding process commences. This is particularly important in high-volume environments.

To ensure that two-dimensional symbols are in fact read properly, finder patterns are commonly embedded in two-dimensional machine-readable symbols. The finder patterns allow the centers of the two-dimensional symbols to be determined so that the two-dimensional symbols can be properly read. For example, in the case of MaxiCode, the finder pattern is in the form of a bull's eye consisting of three concentric black rings. Two-dimensional MaxiCode symbols, which are in the form of grids of hexagons arranged in several rows, are disposed about the finder patterns. Since the rows of hexagons of the MaxiCode symbols are disposed about the finder patterns, locating the centers of the bull's eye finder patterns allows the rows of hexagons to be properly located and read and hence, allows the data encoded in the MaxiCode symbols to be extracted. As will be appreciated, detecting finder patterns in two-dimensional symbols is therefore of great importance.

Depending on the environment and the scanning equipment used to capture images of the two-dimensional symbols being read, the ease by which finder patterns are located in captured images can vary significantly. As a result, a number of techniques for locating finder patterns and decoding two-dimensional symbols have been considered.

For example, U.S. Pat. No. 4,998,010 to Chandler et al. discloses a method for decoding two-dimensional MaxiCode symbols in a high-speed environment. Initially, the two-dimensional symbol is scanned in a first direction and the frequency of black-white transitions is sensed thereby to detect the presence of the finder pattern and hence the center of the two-dimensional symbol. The symbol is then scanned at two additional angles to verify the detected center. The image pixels are normalized to establish each as a light or dark pixel. The image is then re-scaled to create an image with equal horizontal and vertical magnification. A process referred to as “two-dimensional clock recovery” is then employed to determine the position of each hexagon in the data array.

The clock recovery process is used to determine the sampling locations and to correct the effects of warping, curling or tilting. First, the transitions between adjacent contrasting hexagons are enhanced, preferably by standard deviation mapping. A standard deviation map is created to locate the edges of adjacent contrasting hexagons by determining the standard deviations of intensities within 3×3 pixel groups, thus discriminating edge regions from hexagon interiors and regions between like-shaded hexagons. A windowing process is used to reduce the intensity of borders that are not associated with hexagon outlines, namely the concentric rings of the bull's-eye finder pattern and the region surrounding the two-dimensional MaxiCode symbol.

A Fast Fourier Transformation (FFT) is then applied to the image, yielding a two-dimensional representation of the spacing, direction and intensity of the interfaces of contrasting hexagons. The brightest resulting spot is at the center of the transform plane corresponding to the DC component in the image. The six points surrounding the brightest central spot represent the spacing, direction and intensity of the edges between hexagons. All transfer domain points that do not correspond to the desired spacing and direction of hexagon boundaries previously identified are eliminated, leaving six prominent points or blotches. This is performed by zeroing all points within the bull's-eye finder pattern, beyond the radius of the six orientation points, and rotationally removed from the six prominent points. Next, an inverse FFT is performed on the image, followed by the restoration of every hexagon's outline. The correct orientation of the two-dimensional MaxiCode symbol is then determined by testing each of the three axes through the orientation points. The pointer for locating the hexagons containing data is initialized at the orientation marker comprised of three dark hexagons and is moved incrementally outward one hexagon until all desired data is extracted. The data is extracted by determining a grayscale threshold value and setting all values above the threshold as 1 and all values below the threshold as 0. Once the orientation and grid placement are verified, the data may be collected.

U.S. Pat. No. 5,515,447 to Zheng discloses a method for verifying a finder pattern such as the bull's eye in a two-dimensional MaxiCode symbol. Prior to verification, a first row of pixels is selected and the pixels of the row are run-length encoded to determine the number of transitions between black and white. If at least twelve (12) transitions are found, the center white section of pixels in the row is examined to determine if it represents the inner ring of a bull's-eye finder pattern. This is achieved by comparing the length of the center white section of pixels with a predetermined threshold and comparing the widths of the two white sections of pixels both preceding and following the center white section of pixels. If the center white section of pixels satisfies the threshold and the other white sections of pixels being compared are of the same width, a symmetry test is performed to determine if the average lengths of the white sections of pixels and black sections of pixels are very close to one another. If so, a candidate center is declared and the diameter of the entire finder pattern is estimated by summing the lengths of the black and white sections of pixels making up the candidate finder pattern. The column of pixels running through the candidate center, and the pixels along two diagonals running through the candidate center are then examined to determine if they are symmetrical. If so, the mid-point of the center white section of pixels is declared as the center of the finder pattern.

Although the above references disclose techniques for locating the finder pattern in a two-dimensional MaxiCode symbol, improvements to avoid situations where finder patterns are incorrectly identified are desired. It is therefore an object of the present invention to provide a novel method and system for locating and verifying a finder pattern in a two-dimensional machine-readable symbol.

### SUMMARY OF THE INVENTION

Accordingly, in one aspect of the present invention there is provided a method of locating and verifying a finder pattern in a two-dimensional machine-readable symbol, comprising scanning the image along a line to locate a sequence of regions having different optical properties corresponding to that which would be encountered along a line passing through the center of the finder pattern thereby to locate a candidate finder pattern. When a candidate finder pattern is located, a multi-stage verification is performed to verify that the candidate finder pattern is an actual finder pattern.

In one embodiment, one verification stage is a pixel continuity verification and another verification stage is a sequence of regions verification. The pixel continuity verification is based on shape properties of the finder pattern. The finder pattern in this case includes concentric elements. During pixel continuity verification, a determination is made as to whether elements having a common optical property in the located sequence of regions are connected by pixels having the same common optical property, while being isolated from certain other elements in the located sequence of regions. The determination may be performed using a flood-fill algorithm or a contour tracing algorithm.

The sequence of regions verification includes scanning the image along at least one alternate line passing through the center of the located sequence of regions to determine at least one second sequence of regions and confirming that the second sequence of regions corresponds to that which would be encountered along a line passing through the center of the finder pattern.

According to another aspect of the present invention there is provided a method of finding a point in an image that is the common center of a plurality of concentric shapes of one color separated by regions of another color. The method comprises scanning the image line by line to locate a certain symmetrical sequence of regions that alternates in color. When the certain symmetrical sequence of regions is located, a determination is made as to whether related regions of the located sequence are joined by pixels of the same color as well as isolated from unrelated regions of the located sequence. If the determination is satisfied, the mid-point of the located sequence is determined thereby to locate the common center point.

According to yet another aspect of the present invention there is provided a method of finding a point in an image that is the common center of a plurality of concentric shapes of one optical property separated by regions of another optical property. The method comprises scanning the image line by line to locate a desired symmetrical sequence of regions of the image that alternate in optical property. When a candidate desired sequence of regions is located, the image is scanned along a plurality of additional scan lines each passing through the middle of the candidate desired sequence. The additional scan lines form respective angles with the scan line along which the candidate desired sequence was located. The sequences of regions along the additional scan lines are then examined to determine if they correspond to the desired sequence of regions for at least some of the additional scan lines. When the confirmation is made, a determination is made as to whether related regions of the candidate desired sequence are joined by optical elements of the same property as well as isolated from unrelated regions. If the determination is satisfied, the mid-point of the located sequence is determined thereby to locate the common center point.

According to still yet another aspect of the present invention there is provided a system for locating and verifying a finder pattern in a two-dimensional machine-readable symbol, comprising an image scanner scanning the image along a line to locate a sequence of regions having different optical properties corresponding to that which would be encountered along a line passing through the center of the finder pattern thereby to locate a candidate finder pattern. A multi-stage verifier verifies that the candidate finder pattern is an actual finder pattern when a candidate finder pattern is located by the image scanner.

According to still yet another aspect of the present invention there is provided a computer readable medium embodying a computer program for finding a point in an image that is the common center of a plurality of concentric shapes of one color separated by regions of another color. The computer program comprises computer program code for scanning the image line by line to locate a certain symmetrical sequence of regions that alternates in color. Computer program code determines whether related regions of the sequence are joined by pixels of the same color as well as isolated from unrelated regions when the certain symmetrical sequence of regions is located. Computer program code then determines the midpoint of the located sequence thereby to locate the common center point.

According to still yet another aspect of the present invention there is provided a computer readable medium embodying a computer program for finding a point in an image that is the common center of a plurality of concentric shapes of one optical property separated by regions of another optical property. The computer program comprises computer program code for scanning the image line by line to locate a desired symmetrical sequence of regions of the image that alternate in optical property. Computer program code scans the image along a plurality of additional scan lines each passing through the middle of the candidate sequence when a candidate desired sequence of regions is located. The additional scan lines form respective angles with the scan line along which the candidate sequence was located. Computer program code confirms that the sequences of regions along the additional scan lines correspond to the desired sequence of regions for at least some of the additional scan lines. Computer program code determines whether related regions of the candidate sequence are joined by optical elements of the same property as well as isolated from unrelated regions when the confirmation is made. Computer program code then determines the midpoint of the located sequence thereby to locate the common center point.

The present invention provides advantages in that finder patterns in two-dimensional symbols are located and verified with a very high degree of accuracy. As a result, situations where computationally expensive operations are carried out using incorrect starting points as a result of incorrect finder pattern determinations are avoided. An initial computationally inexpensive verification allows candidate finder patterns to be screened. Candidate finder patterns passing the initial verification are then subjected to a more rigorous verification to confirm that the candidate finder patterns are in fact actual finder patterns.

### BRIEF DESCRIPTION OF THE DRAWINGS

Embodiments of the present invention will now be described more fully with reference to the accompanying drawings, in which:

FIG. 1 is an enlarged view of a two-dimensional MaxiCode symbol including a finder pattern;

FIG. 2 is a flow chart showing steps performed in order to locate and verify the finder pattern in the two-dimensional MaxiCode symbol;

FIG. 3 is a flow chart showing further steps performed in order to verify the finder pattern in the two-dimensional MaxiCode symbol;

FIG. 4 is an enlarged view of the two-dimensional MaxiCode symbol of FIG. 1 showing a selected scan line passing through the center of the finder pattern and additional scan lines used to verify initially that the selected scan line passes through the center of the finder pattern;

FIG. 5 shows the black-white transitions or token sequence along the selected scan line passing through the center of the finder pattern identifying a subset of tokens having a sequence corresponding to that of the finder pattern;

FIG. 6 shows the token sequence of FIG. 5 in relation to the finder pattern;

FIG. 7 is an in-progress view showing a determination of pixels of the finder pattern that join the outer tokens of the subset corresponding to that of finder pattern that is made to verify further that the selected scan line passes through the center of the finder pattern;

FIG. 8 is a view similar to that of FIG. 7 showing a determination of all of the pixels of the finder pattern that join the outer tokens of the finder pattern token sequence;

FIG. 9 shows the token sequence of FIG. 5 identifying another subset of tokens having a sequence corresponding to that of the finder pattern;

FIG. 10 shows that token sequence of FIG. 9 in relation to the finder pattern highlighting the discontinuity of the outer tokens of the subset corresponding to that of the finder pattern; and

FIG. 11 is a flowchart showing the steps performed during an alternate pixel continuity verification.

### DETAILED DESCRIPTION OF THE EMBODIMENT

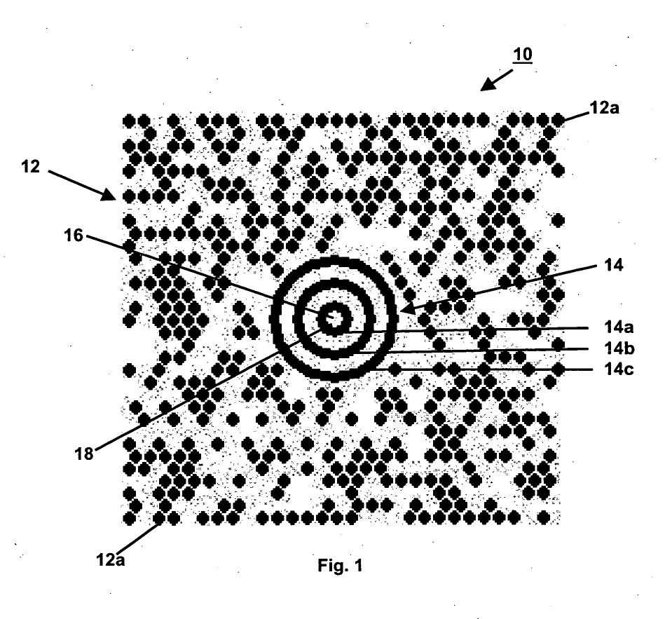

With reference to FIG. 1, a typical two-dimensional MaxiCode symbol is shown and is generally identified by reference numeral 10. As can be seen, the two-dimensional symbol 10 includes a grid 12 of hexagons 12a surrounding a bull's eye finder pattern 14 comprising three dark concentric circular rings 14a, 14b and 14c. The center of the bull's eye finder pattern 14 is coincident with the center point 16 of the two-dimensional symbol 10. Each ring is concentric about the center point 16. The smallest of the dark concentric rings 14a surrounds a white circular region 18 in which center point 16 is centrally disposed.

In use, two-dimensional MaxiCode symbols of the type shown in FIG. 1 are printed on labels that are affixed or otherwise printed on packages and parcels. In this case, the two-dimensional MaxiCode symbols typically carry encoded information pertaining to the packages and parcels on which they are affixed. During processing of a package or parcel carrying such a label, an image of the label, and thus an image of the two-dimensional MaxiCode symbol 10 is captured using a scanner or other imaging device. The scanned two-dimensional symbol image is then conveyed to a processing unit, which firstly determines the location of the finder pattern 14 within the two-dimensional symbol image. Once the finder pattern 14 has been properly located in the two-dimensional symbol image, the two-dimensional symbol image is further processed by the processing unit to read the rows of hexagons 12a thereby to extract the data encoded in the two-dimensional symbol 10.

As mentioned above, properly determining the location of the finder pattern 14 in the two-dimensional symbol image is critical if the data encoded in the two-dimensional symbol is to be extracted properly. Unfortunately, in some instances, the label carrying the two-dimensional symbol may become distorted, discolored or otherwise marred resulting in unclear or otherwise less the ideal two-dimensional symbol images being captured. Also, the orientation and pitch of the label relative to the imaging device used to capture the two-dimensional symbol image may result in variations in two-dimensional symbol image quality.

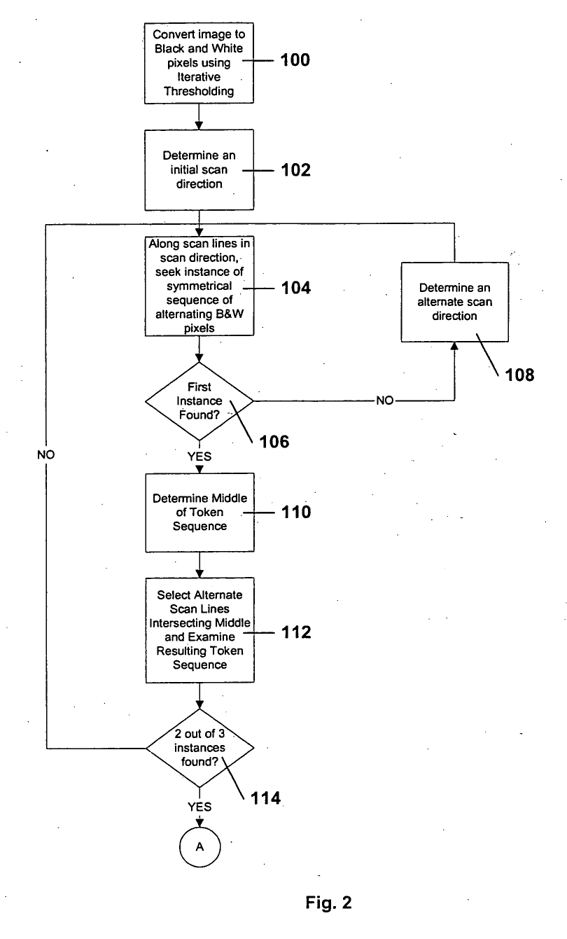

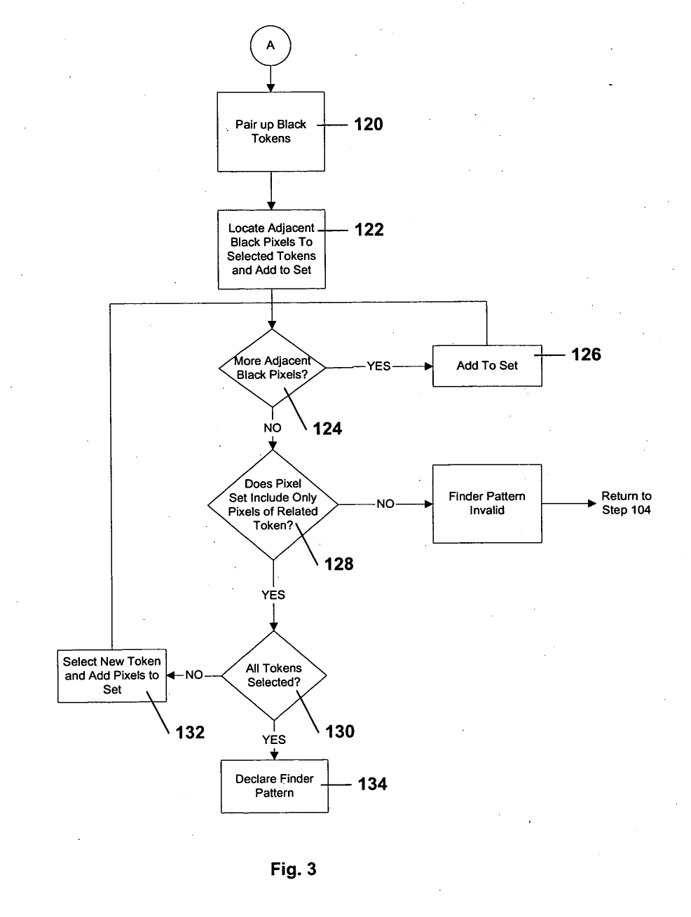

To allow the finder pattern in a two-dimensional symbol image to be accurately determined even in situations where the quality of the two-dimensional symbol image is less than ideal, the processing unit performs a multi-stage verification process to verify the existence of the finder pattern 14 in the two-dimensional symbol image 10. Specifics concerning the manner by which the processing unit locates and verifies the finder pattern in the two-dimensional symbol image will now be described with reference to FIGS. 2 to 10.

Initially, prior to locating the bull's-eye finder pattern 12, the two-dimensional symbol image is converted to a black and white image (step 100). This is performed by converting each pixel in the two-dimensional symbol image to either black or white using an iterative thresholding method.

After the two-dimensional symbol image has been converted to a black and white image, the black and white two-dimensional symbol image is examined to locate the bull's eye finder pattern therein. During this process, an initial scan direction (normally row-wise in the image) is firstly determined (step 102). The two-dimensional symbol image is then scanned along a first selected scan line in the determined scan direction. Consecutive pixels along the selected scan line having the same color are then grouped thereby to yield a sequence of black and white pixel regions, referred to hereafter as tokens. The resulting sequence of tokens is then examined to determine if the token sequence includes a pattern corresponding to that which would be encountered if the scan line passed through the center of the finder pattern i.e. a Black White Black White Black White Black White Black White Black token sequence (step 104). If such a pattern exists, the tokens of the sequence forming the pattern are also compared to adjacent tokens forming the pattern to determine if the tokens are similar in size (step 104).

If the token sequence is determined not to include a pattern corresponding to that of the finder pattern, the two-dimensional image is scanned along the next scan line in the determined scan direction and the above steps are re-performed. This row-by-row scanning is carried out until a sequence of tokens is located that corresponds to that of the finder pattern (step 106). If all rows of the two-dimensional symbol image are scanned in the determined scan direction and a sequence of tokens corresponding to that of the finder pattern is not located, an alternate scan direction that forms an angle with the initial scan direction is determined (step 108) and the above steps are re-preformed. As will be appreciated, steps 104 and 108 are performed either until a candidate finder pattern has been located or scanning directions over 180 degrees have been used.

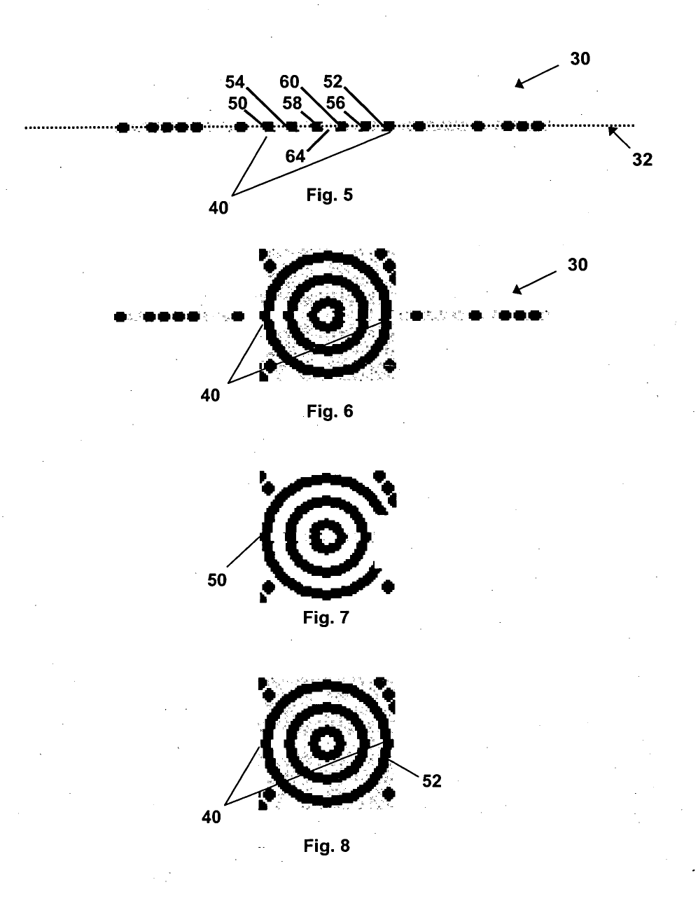

FIGS. 5 and 6 show the resulting sequence 30 of tokens generated for a scan line 32 passing through the center of the bull's eye finder pattern 14. As can be seen, a subset 40 of the tokens has a pattern or sequence corresponding to that of the finder pattern. Thus, the subset 40 of tokens forming the pattern includes first and sixth outer black tokens 50, 52, second and fifth intermediate black tokens 54, 56 and third and fourth inner black tokens 58, 60. The tokens of the above pairs are related in that they are joined by consecutive bands of black pixels while being isolated from tokens of the other pairs.

Once a candidate finder pattern has been located at step 106, a two-stage finder pattern verification process is performed to confirm that the candidate finder pattern is in fact an actual finder pattern. During the first verification stage, a search for token sequence repetitions along different scan lines passing through the center of the candidate finder pattern is made. During the second verification stage, a search of the two-dimensional symbol image for token continuity is made. If the results of the verification stages are positive, the candidate finder pattern is deemed to be an actual finder pattern and the located and verified finder pattern is used to read and decode the two-dimensional symbol image. If the results of one or both of the verification stages is negative, the candidate finder pattern is deemed not to be an actual finder pattern. In this case, the two-dimensional symbol image is searched further until another candidate finder pattern is located at which time the two-stage verification process is re-performed.

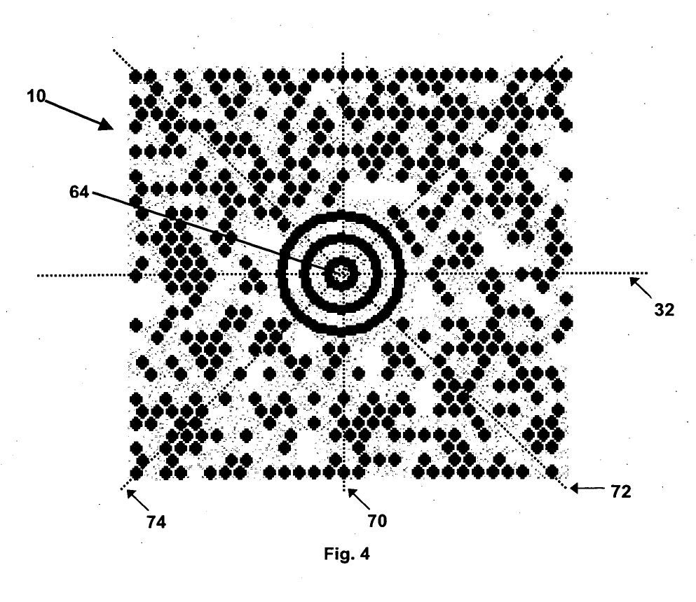

During the first verification stage, the midpoint 64 of the token sequence 40 corresponding to that of the finder pattern is determined (step 110). A second scan line 70 as shown in FIG. 4, which passes through the midpoint 64 at a 90 degree angle to the scan line 32 is identified. The pixels along the second scan line are then grouped into black and white tokens and the resulting sequence of tokens is examined to determine if the token sequence includes a pattern corresponding to that of the finder pattern (step 112). The middle token along this second resulting sequence (a white token) must contain at least one pixel in common (i.e. overlap) with the middle token of the token sequence 40 in order for a match to be declared.

Step 112 is then repeated for two more scan lines 72 and 74 that pass through the midpoint 64 of the token sequence 40 at angles of 45 and 135 degrees to the scan line 32. In order to satisfy the first verification stage, the token sequence generated for at least two of the three additional scans must include the same pattern as that of the finder pattern (step 114).

If the token sequences generated for two or more of the additional scans do not include a pattern of tokens corresponding to that of the finder pattern, the candidate finder pattern is deemed not to be an actual finder pattern and the process reverts back to step 104.

The first verification stage, due to its simplicity, provides a computationally inexpensive means of identifying when a candidate finder pattern is clearly not an actual finder pattern. The simplistic nature of the first verification stage however, is not determinative in that it is possible that the two-dimensional symbol includes hexagons arranged in a pattern that resembles the token sequence of the finder pattern.

The second verification stage is more rigorous and makes use of the fact that the finder pattern 14 comprises three continuous concentric rings 14a to 14c. Based on this property, any black pixel in a ring is connectable via black pixels to any other pixel in the same ring. Pixels in one ring cannot be connected to pixels in any of the other rings. Thus, the black pixels of the outer tokens 50, 52 in the token sequence 40 should be connected by a continuous band of black pixels and isolated from the remaining tokens in the sequence 40 (i.e. the second, third, fourth and fifth black tokens) if the scan line passes through the center of the finder pattern 14, since these tokens form part of the same ring 14c. Similarly the second and fifth black tokens 54, 56 in the token sequence 40 should be connected by a continuous band of black pixels and isolated from the first, third, fourth and sixth black tokens. Likewise, the third and fourth black tokens 58, 60 in the token sequence 40 should be connected by a continuous band of black pixels and isolated from the first, second, fifth and sixth black pixels.

During the second verification stage, pixels in the two-dimensional symbol image are examined to determine whether the above pixel continuity conditions exist in respect of the tokens of the token sequence 40.

In order to determine whether related pairs of black tokens in the token sequence 40 are connected without being connected to other black tokens in the sequence 40, the processing unit pairs up the black tokens in the token sequence (step 120) and executes a flood-fill algorithm starting with the pixels in the first black token 50 of the token sequence. During execution of the flood-fill algorithm, all pixels immediately adjacent each pixel in the first black token are located and, if they are black, are added to a set (step 122). Depending on the resolution of the image and the optimization of the performance of the flood-fill algorithm, there may be four adjacent pixels (top, bottom, left, right) or eight adjacent pixels (corner pixels plus top, bottom, left, right). Next, pixels adjacent to the pixels that have been added in the set are found, and if they too are black, they are added to the set (steps 124 and 126). This process is continued until the set is complete, that is, until no more successively adjacent black pixels can be found. Once the pixel set is complete, the pixel set is examined to determine whether the pixel set includes the pixels of any of the other tokens in the token sequence 40 (step 128).

FIG. 7 shows a partially completed pixel set including black pixels that are continuous with the first black token 50 and FIG. 8 shows the completed pixel set. In this case, the completed pixel set includes the pixels of the sixth black token 52 but none of the pixels of the remaining black tokens 54 to 60.

At step 128, if the pixel set includes the pixels of sixth black token 52 but none of the pixels of the second, third, fourth and fifth black tokens, the second verification stage continues and the above steps are performed starting with a pixel in the second black token 54 (steps 130 and 132). When the resulting pixel set for the second black token is complete, the pixel set is examined to confirm that the pixel set includes the pixels of the fifth black token 56 but not pixels of the first, third, fourth or sixth tokens. If this condition is satisfied, the second verification stage continues and the above steps are performed yet again starting with a pixel in the third token 58 (steps 130 and 132). When the resulting pixel set for the third black token is complete, the pixel set is examined to confirm that the pixel set includes the pixels of the fourth black token 60 but not pixels of the first, second, fifth or sixth tokens.

If this condition is satisfied, the second verification stage is completed and the candidate finder pattern is positively identified as an actual finder pattern (step 134). Following this, the more computationally expensive process of decoding the two-dimensional symbol 10 can begin.

During the second verification stage, if at any time a completed set of pixels does not satisfy the pixel continuity conditions, the second verification stage is terminated and the candidate finder pattern is deemed not to be an actual finder pattern. At this point, the process reverts back to step 104 so that the two-dimensional symbol image can be searched further for a candidate finder pattern.

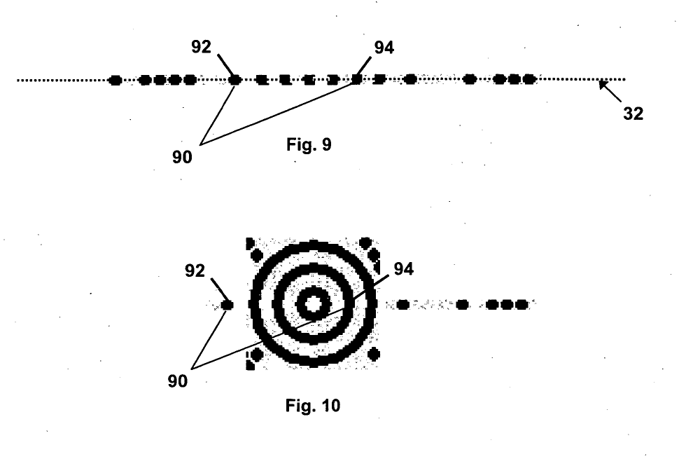

FIGS. 9 and 10 illustrate the case where the second verification stage successfully determines that a candidate finder pattern is not an actual finder pattern. As can be seen in FIG. 9, the scan line 32 is again shown however in this case, the sequence 90 of the tokens that corresponds to that of the finder pattern is being processed. During processing of token sequence 90, when the second verification process is being performed, the discontinuity between the first and sixth tokens 92, 94 of the token sequence becomes evident allowing token sequence 90 to be discounted as that corresponding to the finder pattern.

If the entire two-dimensional symbol image is processed and an actual finder pattern is not located, the original two-dimensional symbol image is converted to a black and white image using an adaptive thresholding method and the above steps are re-performed. If this fails to yield an actual finder pattern, the two-dimensional symbol image is deemed unreadable.

By performing the above multi-stage verification, finder patterns in two-dimensional symbols are located and verified with a very high degree of accuracy avoiding situations from arising where computationally expensive operations are carried out using incorrect starting points as a result of incorrect finder pattern determinations.

To complete the decoding process once the finder pattern has been located and verified, the diameter of the bull's-eye finder pattern is determined by averaging the length of its constituent tokens along both the row and column and calculating the mean of the two averages. If the bull's-eye finder pattern diameter is less than sixty-four (64) pixels, the entire two-dimensional symbol image is doubled in size. The coordinates for the center of the bull's-eye finder pattern and its diameter are then adjusted accordingly.

The two-dimensional symbol image is then cropped around a square whose center is the same as the center of the bull's-eye finder pattern and whose width and height are based on the diameter of the bull's-eye finder pattern. An edge image is then created from the edge locations between light and dark regions of the two-dimensional symbol image. The edge image is first transformed from its space domain representation into a frequency domain image using a two-dimensional Fast Fourier Transformation (FFT), and then rearranged so that the DC component of the frequency domain image is centered. The resulting image includes six blotches around its center. The resulting image is then conditioned using an adaptive threshold technique to isolate the six blotches and zero out the rest of the image.

Once the six blotches have been isolated in the frequency domain image, the image is used to create a reference grid image by converting the frequency domain image into its space domain counterpart using an inverse FFT. Because the frequency domain image is point symmetric about the origin due to it being comprised of non-complex values, only half of the image is required in order to convert the entire image to its space-domain counterpart. By exploiting the symmetry, overall computation is minimized. To further minimize computation, the inverse FFT is performed only on the isolated, non-zero portions of the frequency domain image, as the isolated blotches provide all of the information necessary for creating a useful reference grid.

The newly created reference grid image shows the centers of the hexagons in the symbol image. The six blotches in the conditioned frequency domain image define three axes that are then employed to identify the orientation patterns in the symbol image and thus, orient the symbol image. The reference grid image is used to create a reference grid map, which is in turn adjusted to correspond to the determined proper orientation of the symbol image. The bit information is then read from the oriented symbol image using the oriented reference grid map. The bit stream is error-corrected using, for example, a procedure as described in the AIM Specification Decode Algorithm.

While the first verification stage is described as utilizing additional scans at 45°, 90° and 135° angles to provide an initial low-cost verification, it will be appreciated that more or fewer additional scan lines and/or additional scan lines at other angles may be used. Also, it will be appreciated that this initial verification stage may be omitted. In this case, only pixel continuity verification is used to verify the candidate finder pattern.

Although the image is described as being converted to black and white pixels, those of skill in the art will appreciate that the present invention is not limited to images characterized by pixels or bitmaps. The verification process may be used to locate the finder pattern in an image whose elements are encoded or depicted by some other means, such as for example by vector definition. In this case, the symbol image would simply need to be converted prior to processing so that it is represented as discrete elements having two optical properties. Furthermore, for the purposes of locating and verifying the finder pattern, the image may be represented in a single colour such as black with alternate shades or consistencies, or multiple alternate colours, as long as the elements in the image representing the rings of the finder pattern have at least one optical property in common that may be identified as distinguishable from the remainder of the image.

While specific reference to locating and verifying a MaxiCode bull's eye finder pattern including three concentric rings is made, those of skill in the art will appreciate that the present invention is suitable for use in locating and verifying other finder patterns in two-dimensional symbols. For example, the finder pattern may include multiple concentric square, circular or otherwise-shaped rings in a symbol image. For instance, QR Code includes finder patterns in the form of two (2) concentric squares located at various points throughout the symbol, and Aztec Code includes finder patterns in the form of three (3) concentric squares at the center of the symbol.

During execution of the flood-fill algorithm successively connected pixels need not be collected to form a set. Rather, connected pixels can simply be compared to the coordinates of the appropriate annular regions encompassing the related tokens to determine if the token connectivity criteria are met.

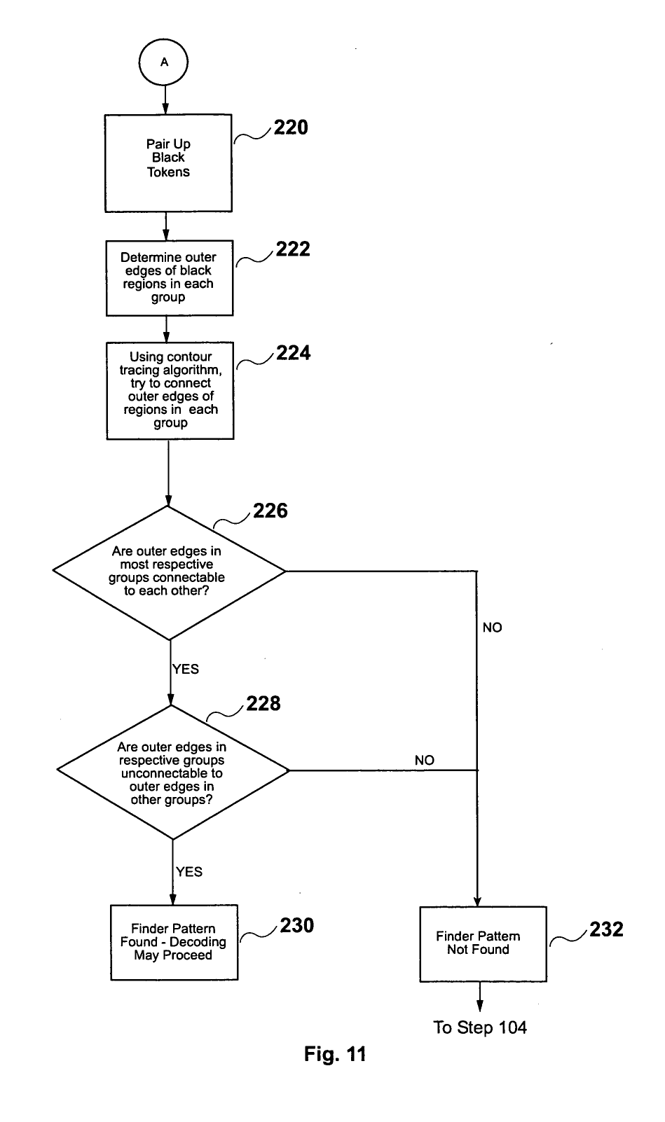

While the flood-fill algorithm has been described for use in determining pixels in one token that are successively connected to pixels in a related token, other methods may be used to determine token pixel continuity. For example, rather than using a flood-fill algorithm, a contour-tracing algorithm can be employed which connects the edges (inner or outer) of counterpart regions of pixels in the scan line sequence to determine if the edges of the rings are connectable. FIG. 11 shows the steps performed when using such a contour-tracing algorithm. As can be seen, after initial verification, the black tokens are again grouped or paired up (step 220). Instead of determining all successively adjacent black pixels, the outer edges of the regions in respective groups are determined (step 222) and just the outer edges of the regions are examined to detect connectivity using the contour-tracing algorithm (step 224). If the outer edges in a group are themselves connectable (step 226) while remaining unconnectable to the edges of other groups (step 228), the finder pattern is deemed to have been found (step 230). Otherwise, the finder pattern is deemed not to be an actual finder pattern (step 232) and the process reverts back to step 104.

The processing unit may include discrete components to locate and verify the finder pattern in a two-dimensional symbol or may execute appropriate software or computer readable program code stored on a computer readable medium. The computer readable medium is any data storage device that can store data, which can thereafter be read by a computer system. Examples of computer readable medium include read-only memory, random-access memory, CD-ROMs, magnetic tape and optical data storage devices. The computer readable program code can also be distributed over a network including coupled computer systems so that the computer readable program code is stored and executed in a distributed fashion.

Although preferred embodiments of the present invention have been described, those of skill in the art will appreciate that variations and modifications may be made without departing from the spirit and scope thereof as defined by the appended claims.

What is claimed is:

1. A method of locating and verifying a finder pattern in a two-dimensional machine-readable symbol, comprising:
scanning the image along a line to locate a sequence of regions having different optical properties corresponding to that which would be encountered along a line passing through the center of said finder pattern thereby to locate a candidate finder pattern; and
when a candidate finder pattern is located, performing a multi-stage verification to verify that the candidate finder pattern is an actual finder pattern.

2. The method of claim 1 wherein one verification stage is a pixel continuity verification.

3. The method of claim 2 wherein another verification stage is a sequence of regions verification.

4. The method of claim 2, wherein said pixel continuity verification is based on shape properties of said finder pattern.

5. The method of claim 4 wherein said finder pattern includes concentric elements.

6. The method of claim 3, wherein said sequence of regions verification comprises:
scanning the image along at least one alternate line passing through the center of said located sequence of regions to determine at least one second sequence of regions; and
confirming that the second sequence of regions corresponds to that which would be encountered along a line passing through the center of said finder pattern.

7. The method of claim 6 comprising scanning the image along a plurality of alternate lines, each forming a different angle with respect to the line along which the sequence of regions was located.

8. The method of claim 5, wherein said pixel continuity verification comprises:
determining if certain elements having a common optical property in said located sequence of regions are connected by pixels having the same common optical property, while being isolated from certain other elements in said located sequence of regions.

9. The method of claim 8, wherein said determining is performed using a flood-fill algorithm.

10. The method of claim 8, wherein said determining is performed using a contour tracing algorithm.

11. The method of claim 1 wherein said finder pattern includes concentric elements and wherein during said scanning consecutive pixels of the same color are grouped to form pixel tokens and wherein the sequence of tokens along said line is examined to determine whether the sequence of tokens includes a pattern corresponding to that of the finder pattern and whether the tokens in the sequence are generally equal in width.

12. The method of claim 11 wherein one verification stage is a pixel continuity verification.

13. The method of claim 12 wherein said pixel continuity verification comprises:
determining whether related tokens in the sequence are joined by continuous bands of pixels of the same color while being isolated from unrelated tokens.

14. The method of claim 13, wherein said determining is performed using a flood-fill algorithm.

15. The method of claim 13, wherein said determining is performed using a contour tracing algorithm.

16. The method of claim 1 further comprising scanning the image along consecutive lines to locate a candidate finder pattern.

17. The method of claim 16 further comprising selecting an initial scan direction prior to commencing said scanning.

18. The method of claim 17 further comprising selecting an alternative scan direction if a finder pattern is not located after all consecutive lines of said image have been scanned using said initial scan direction.

19. The method of claim 18 wherein one verification stage is a pixel continuity verification.

20. The method of claim 19, wherein said pixel continuity verification is based on shape properties of said finder pattern.

21. The method of claim 20, wherein said finder pattern includes concentric elements and wherein said pixel continuity verification comprises:
determining if certain elements having a common optical property in said located sequence of regions are connected by pixels having the same common optical property, while being isolated from certain other elements in said located sequence of regions.

22. The method of claim 21 wherein during scanning along each line, consecutive pixels of the same color are grouped to form pixel tokens and wherein the sequence of tokens along said line is examined to determine whether the sequence of tokens has a pattern corresponding to that of the finder pattern and whether the tokens in the sequence are generally equal in width.

23. The method of claim 22 wherein another verification stage is a sequence of regions verification, said sequence of regions verifications being performed prior to said pixel continuity verification.

24. The method of claim 23, wherein said sequence of regions verification comprises:
scanning the image along at least one alternate line passing through the center of said located sequence of regions to determine at least one second sequence of regions; and
confirming that the second sequence of regions corresponds to that which would be encountered along a line passing through the center of said finder pattern.

25. The method of claim 24 comprising scanning the image along a plurality of alternate lines, each forming a different angle with respect to the line along which the sequence of regions was located.

26. A method of finding a point in an image that is the common center of a plurality of concentric shapes of one color separated by regions of another color, the method comprising:
scanning said image line by line to locate a certain symmetrical sequence of regions that alternates in color;
when said certain symmetrical sequence of regions is located, determining whether related regions of said located sequence are joined by pixels of the same color as well as isolated from unrelated regions of the located sequence; and
if the determination is satisfied, determining the midpoint of the located sequence thereby to locate the common center point.

27. The method of claim 26, wherein said concentric shapes comprise at least two concentric rings.

28. The method of claim 27, wherein said concentric rings are circular.

29. The method of claim 28, wherein said determining is performed using a flood-fill algorithm.

30. The method of claim 27, wherein said determining is performed using a contour-tracing algorithm.

31. The method of claim 27 wherein the concentric shapes are a finder pattern of a two-dimensional machine-readable symbol.

32. A method of finding a point in an image that is the common center of a plurality of concentric shapes of one optical property separated by regions of another optical property, the method comprising:
scanning said image line by line to locate a desired symmetrical sequence of regions of said image that alternate in optical property;
when a candidate desired sequence of regions is located, scanning the image along a plurality of additional scan lines each passing through the middle of said candidate sequence, said additional scan lines forming respective angles with the scan line along which the candidate sequence was located;
confirming that the sequences of regions along the additional scan lines correspond to said desired sequence of regions for at least some of the additional scan lines;
when said confirmation is made, determining whether related regions of said candidate sequence are joined by optical elements of the same property as well as isolated from unrelated regions; and
if the determination is satisfied, determining the midpoint of the located sequence thereby to locate the common center point.

33. The method of claim 32 wherein the image is scanned along at least three different additional scan lines and wherein the confirmation is made when for at least two of the additional scan lines, the sequences of regions along the additional scan lines correspond to the desired sequence of regions.

34. A system for locating and verifying a finder pattern in a two-dimensional machine-readable symbol, comprising:
an image scanner scanning the image along a line to locate a sequence of regions having different optical properties corresponding to that which would be encountered along a line passing through the center of said finder pattern thereby to locate a candidate finder pattern; and
a multi-stage verifier verifying that the candidate finder pattern is an actual finder pattern when a candidate finder pattern is located by said image scanner.

35. A system according to claim 34 wherein multi-stage verifier firstly performs a sequence of regions verification and then performs a pixel continuity verification.

36. A system according to claim 35, wherein said pixel continuity verification is based on shape properties of said finder pattern and wherein said finder pattern includes concentric elements.

37. A system according to claim 36, wherein during said pixel continuity verification, said multi-stage verifier determines if certain elements having a common optical property in the located sequence of regions are connected by pixels having the same common optical property, while being isolated from certain other elements in said located sequence of regions.

38. A system according to claim 34 wherein said image scanner scans the image along consecutive lines to locate a candidate finder pattern.

39. A system according to claim 38 wherein said image scanner selects an initial scan direction prior to commencing said scanning and then selects an alternative scan direction if a finder pattern is not located after all consecutive lines of said image have been scanned.

40. A computer readable medium embodying a computer program for finding a point in an image that is the common center of a plurality of concentric shapes of one color separated by regions of another color, said computer program comprising:
computer program code for scanning said image line by line to locate a certain symmetrical sequence of regions that alternates in color;
computer program code for determining whether related regions of said sequence are joined by pixels of the same color as well as isolated from unrelated regions when said certain symmetrical sequence of regions is located; and
computer program code for determining the midpoint of the located sequence thereby to locate the common center point.

41. A computer readable medium embodying a computer program for finding a point in an image that is the common center of a plurality of concentric shapes of one optical property separated by regions of another optical property, the computer program comprising:
computer program code for scanning said image line by line to locate a desired symmetrical sequence of regions of said image that alternate in optical property;
computer program code for scanning the image along a plurality of additional scan lines each passing through the middle of said candidate sequence when a candidate desired sequence of regions is located, said additional scan lines forming respective angles with the scan line along which the candidate sequence was located;
computer program code for confirming that the sequences of regions along the additional scan lines correspond to said desired sequence of regions for at least some of the additional scan lines; and
computer program code for determining whether related regions of said candidate sequence are joined by optical elements of the same property as well as isolated from unrelated regions when said confirmation is made; and
computer program code for determining the midpoint of the located sequence thereby to locate the common center point.
